(19) United States
(12) Patent Application Publication
(10) Pub. No.: US 2010/0147758 A1
(43) Pub. Date: Jun. 17, 2010

(54) TENSION-FORCE COUPLED HIGH-PRESSURE PUMPING

(75) Inventor: Haertl Hans-Georg, Karlsruhe (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/515,092

(22) PCT Filed: Nov. 15, 2006
(86) PCT No.: PCT/EP06/68515

§ 371 Date: Feb. 4, 2010

(51) Int. Cl. B01D 15/08; F04B 53/10; F04B 17/03; F04B 23/06; F04B 9/02; B01D 29/90

(52) U.S. Cl. 210/198.2; 417/437; 417/559; 417/415; 417/254; 417/53; 210/416.1

(57) ABSTRACT

A pumping apparatus (200) for delivering liquid at a high pressure (Psys) at which compressibility of the liquid becomes noticeable, comprises a piston (20) adapted for reciprocation in opposing directions in a pump working chamber (30), and a drive (40) coupled to the piston (20) to apply a tension force onto the piston (20) in order to move the piston (20) into a drive direction (50).

### BACKGROUND ART

The present invention relates to delivering liquid at a high pressure at which compressibility of the liquid becomes noticeable.

FIG. 1 illustrates a typical example of a pump 10, as known in the art, for delivering liquid at a high pressure at which compressibility of the liquid becomes noticeable. An example of such pump 10 is disclosed e.g. in EP 0309596 A1.

The pump 10 comprises a piston 20 reciprocating in opposing directions in a pump working chamber 30. A drive 40, e.g. a spindle drive as in the aforementioned EP 0309596 A1, is coupled to the piston 20 and applies a pressure force in a direction as indicated by arrow 50, in order to move the piston into the direction 50, thus decreasing a pump volume 60. The pump volume 60 is usually provided by the volume between the piston 20 and the pump working chamber 30 and usually further includes the volume of the working chamber 30 up until an inlet valve 70 and/or an outlet valve 80. The pump volume 60 is usually further defined by a drive seal 90 applied for sealing the pump working chamber against or in the direction of the drive 40.

A return mechanism 100, which can be e.g. a spring mechanism, is usually provided and coupled to the piston 20 for counteracting against the movement of the piston 20 into the drive direction 50. Once the piston 20 reaches its top dead center, i.e. when the pump volume 60 is minimized, the return mechanism 100—usually in combination with the pressure in the pump working chamber 30—moves the piston 20 in a return direction 55 opposite to the drive direction 50. Thus, the pump volume 60 is increased during the movement into the return direction.

The movement of the piston 20 into the drive direction 50 is usually provided to compress the liquid in the pump working chamber 30. Dependent on the settings of the valves 70 and 80, the compression of the liquid during movement into the drive direction 50 is usually done in order to provide a system pressure Psys at an outlet 110 of the pump 10. Movement of the piston 20 into the return direction 55 is usually provided to fill the pump working chamber 30 with liquid provided at an inlet 120 of the pump 10. The inlet 120 might be coupled to a liquid reservoir (usually at ambient pressure) or to another pump for supplying the liquid. This is indicated in FIG. 1 by a liquid supply 130 supplying the liquid to the pump 10 at a pressure Psup.

### DISCLOSURE

It is an object of the invention to provide an improved delivering of liquid at a high pressure at which compressibility of the liquid becomes noticeable. The object is solved by the independent claim(s). Further embodiments are shown by the dependent claim(s).

Embodiments according to the present invention provide a pumping apparatus for delivering liquid at a high pressure at which compressibility of the liquid becomes noticeable. The pumping apparatus comprises a piston for reciprocating in opposing directions in a pump working chamber. A drive is coupled to the piston in order to apply a tension force onto the piston in order to move the piston into a drive direction.

The tension force coupling between the drive and the piston allows providing an easier design of the mechanical alignment of the piston in the pump working chamber with respect to the pressure force coupling as illustrated in FIG. 1. The pressure coupled drive in FIG. 1 requires a very sophisticated design of the lateral guidance of the piston in the working chamber, since the piston has a tendency to swerve in a direction perpendicular to the direction of movement under the application of the pressure force from the drive. The application of a force coupling between the piston and the drive, as in embodiments of the present invention, reduces the requirements for lateral guidance of the piston, thus leading to a less complex and usually less costly design together with a reduced abrasion in particularly for the sealing.

A piston which is moved (pushed) by pressure coupling usually has to provide certain bending resistance and requires a very precise lateral guidance. This typically limits the applicable length and thus the diameter to length ratio. The lateral guiding has to be narrow and/or long, so that the piston cannot swerve in lateral direction. This requires tight tolerances and leads to friction and abrasion. Sealings usually have to be quite hard to cover lateral forces resulting from swerving of the piston. At the same time, such seal(ing)s have to be elastic to ensure the sealing quality.

Using tension coupling of the piston allows overcoming at least some of the constraints of pressure coupled pistons. The requirements on lateral guidance are limited since swerving can be reduced, thus also allowing to use different seal(ing)s with lower requirements to hardness. Further, different materials may be used and the applicable length and/or diameter to length ratio can be improved.

In one embodiment, a return seal is provided for sealing liquid in the pump working chamber against a return mechanism provided for counteracting against the movement of the piston. The return mechanism is preferably also coupled to the piston and adapted to move the piston into a return direction opposite to the drive direction as provided by the drive. The return mechanism might also be tension force coupled to the piston to apply a tension force into the return direction.

The pumping apparatus might further comprise a drive seal for sealing the pump working chamber against the drive. The drive seal might be provided in the pump working chamber, so that the piston abuts to the drive seal in order that liquid is retained in the pump volume of the pump working chamber and prohibited from leaving the pump volume into the direction of the point of application of the drive.

While the pumping apparatus of FIG. 1 usually requires only the drive seal, embodiments according to the present invention might require such return seal, which might be provided alternatively or in addition to the drive seal, in order to seal the pump volume at the point of application of the return mechanism.

The drive seal and/or the return seal can be embodied e.g. by spring assisted PTFE (Polytetrafluorethylen) based polymeric seals, or any other high pressures sealing has known in the art.

In one embodiment the pump volume is increased when the piston is moved into the drive direction by the drive tension force coupled to the piston. Accordingly, the pump volume is than decreased when the piston is moved into the return direction.

In one embodiment, the piston is coupled on both ends a respective drive, each applying tension force onto the piston to move (pull) the piston in a respective direction.

In order to provide a unidirectional flow of the liquid, one or more valves might be provided and coupled to the pump working chamber. An outlet might be coupled to the pump working chamber for outletting the liquid at the high pressure. Such outlet might comprise an outlet valve adapted to permit liquid flow only unidirectional. An inlet might be coupled to the pump working chamber for inletting the liquid into the pump working chamber. The pressure of the liquid at the inlet is usually lower than the pressure at which the pumping apparatus outputs the liquid. The inlet might comprise an inlet valve to permit liquid flow only unidirectional.

The outlet valve and/or the inlet valve might be embodied by or comprise a check valve, active valves, rotary slide valves, or any other valve as known in the art adapted to ensure unidirectional flow of the liquid.

The piston can be provided using any kind of suitable material. Typical requirements in embodiments might be to provide one or more of the following: sufficient hardness (in particular to reduce abrasion), sufficiently durability (e.g. chemically inert) in particular against chemical solvents e.g. as used in chromatography, sufficient surface quality in particular to ensure sufficient sealing, long life time, etc. Embodiments of the piston might comprise at least one of the following materials: hard metal (e.g. carbide, tungsten carbide WC, etc.), ceramic materials (such as ZrO2, Al2O3, TiC, SSiC, Si3N4, etc.), stainless steel (in particular temperable stainless steel), titanium, etc.

The piston might be at least partially coated, e.g. with a diamond-like carbon coating, adapted to provide a reduced abrasion of the piston, e.g. against the drive seal and/or the pump working chamber. The teaching of the European Patent application 06117516.2, by the same applicant, with respect to such coating shall be incorporated hereby by reference.

The drive might comprise a spindle drive mechanism as described in detail in the aforementioned EP 309596 A1, the teaching thereof with respect to the drive mechanism shall be incorporated herein by reference. Other couplings might comprise one or more of a cam disc, a gear drive, etc.

The return mechanism might comprise at least one of a spring, a hydraulic cylinder, a drive mechanism, a deflection mechanism, as known in the art. Alternative, a separate drive might be used which is tension forced coupled to the piston and couples from an opposite direction as the drive. In one embodiment, a return rod is coupled between the piston and the return mechanism. The rod and the piston might be provided as one piece, or might be coupled to each other using force or form coupling as known in the art.

In one embodiment, the pumping apparatus is coupled with another pumping apparatus, whereby both pumping apparatuses might be embodied in the same way but may also be different. Providing two pumping apparatuses allows to provide an essentially continuous liquid flow, as well known in the art and also explained in detail in the aforementioned EP 309596 A1. Such so called dual pump might comprise the two pumping apparatuses in either a serial or a parallel manner. In the serial manner, as disclosed in the aforementioned EP 309596 A1, the outlet of one pumping apparatus is coupled to the inlet of the other pumping apparatus. The teaching in the EP 309596 A1 with respect to the operation and embodiment of such serial dual pump shall be incorporated herein by reference.

In the parallel manner, the inlets and the outlets, respectively, of both pumping apparatuses are coupled together.

In both manners, serial and parallel, operation of the two pumping apparatuses is phase shifted, usually by about 180 degrees. The phase shifting might be varied in order to compensate pulsation in the flow of liquid as resulting from the compressibility of the liquid.

Embodiments of the afore described pumping apparatus might be applied in a liquid separation system comprising a separating device, such as a chromatographic column, having a stationary phase for separating compounds of a sample liquid in a mobile phase. The mobile phase is then driven by the pump. Such separation system might further comprise at least one of a sampling unit for introducing the sample fluid into the mobile phase, a detector for detecting separated compounds of the sample fluid, a fractionating unit for outputting separated compounds of the sample fluid, or any other device or unit applied in such liquid separation systems.

Embodiments of the invention can be partly or entirely supported by one or more suitable software programs, which can be stored on or otherwise provided by any kind of data carrier, and which might be executed in or by any suitable data processing unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 illustrates a typical example of a pump 10 as known in the art.

FIGS. 2 and 3 show exemplary embodiments of a pumping apparatus 200 according to the present invention.

FIG. 4a shows an embodiment of a serial dual pump, and FIG. 4b shows an embodiment of a parallel dual pump.

FIG. 5 shows a liquid separation system 500.

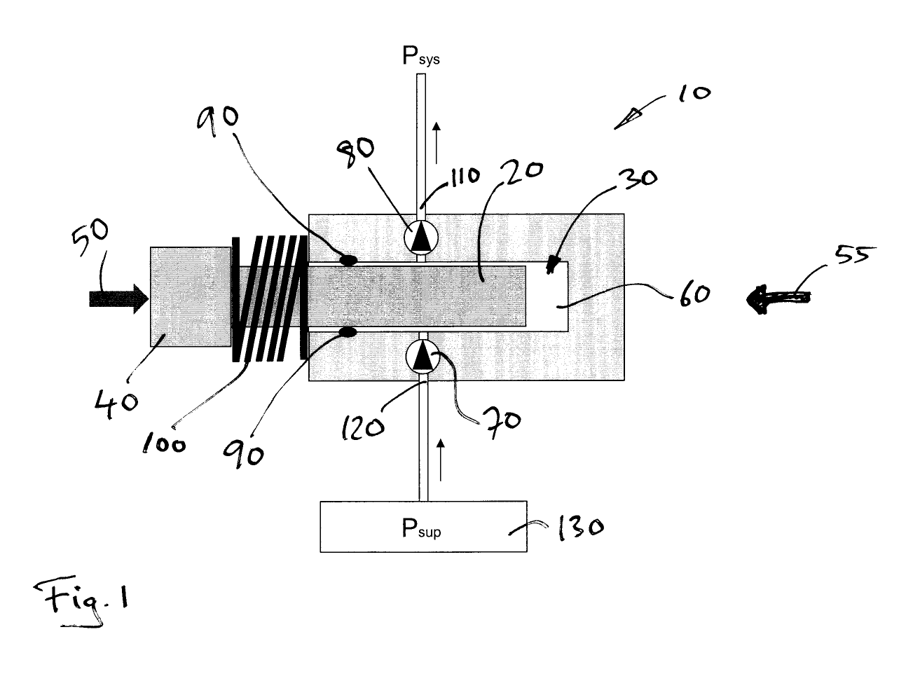

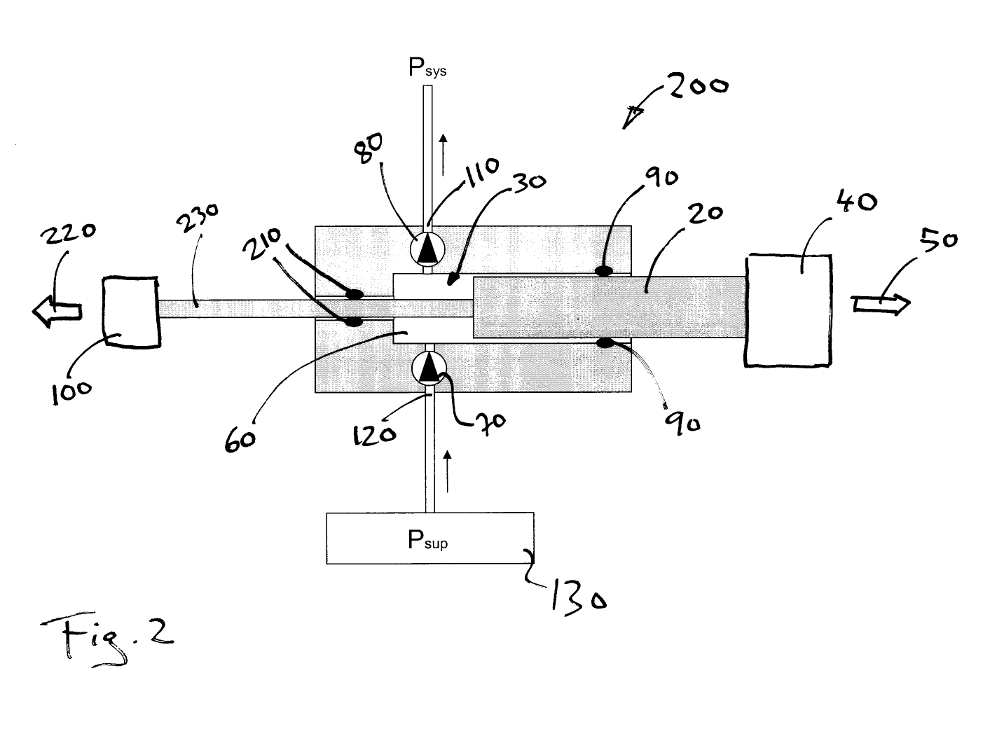

In FIG. 2, as also illustrated with respect to FIG. 1, the piston 20 reciprocates in opposing directions in the pump working chamber 30. However, whereas in FIG. 1 the drive 40 is pressure force coupled to the piston 20 and “pushes” the piston 20 into the pump working chamber 30 in order to reduce the pump volume 60, the drive 40 in FIG. 2 is tension force coupled to the piston 20 and applies a tension force onto the piston 20 in order to “draw/pull” the piston 20 into the direction 50 was increasing the pump volume.

An input valve 70 might be provided in order to ensure that liquid provided at the input 20 (as received e.g. from a liquid reservoir or another pump, as indicated by reference numeral 130) can flow only unidirectional into the pump working chamber but not in return.

An outlet valve 80 might be provided at the outlet 110 of the pumping apparatus 200 in order to ensure unidirectional flow of the liquid from the pump working chamber into the system as coupled to the pumping apparatus 200.

The piston 20 is preferably sealed by the drive seal 90 in order to retain the liquid in the pump volume 60. In the embodiment of FIG. 2, a return seal 210 is provided in order to seal the pump volume 60 against a return rod 230 coupled to the return mechanism 100. The return mechanism 100 is provided to move the piston 20 into a return direction 220 opposite to the drive direction 50.

The application of force coupling between the piston 20 and the drive 40, as in embodiments of the present invention, reduces the requirement for lateral guidance of the piston 20, thus leading to a less complex and usually less costly design together with a reduced abrasion in particularly for the sealing.

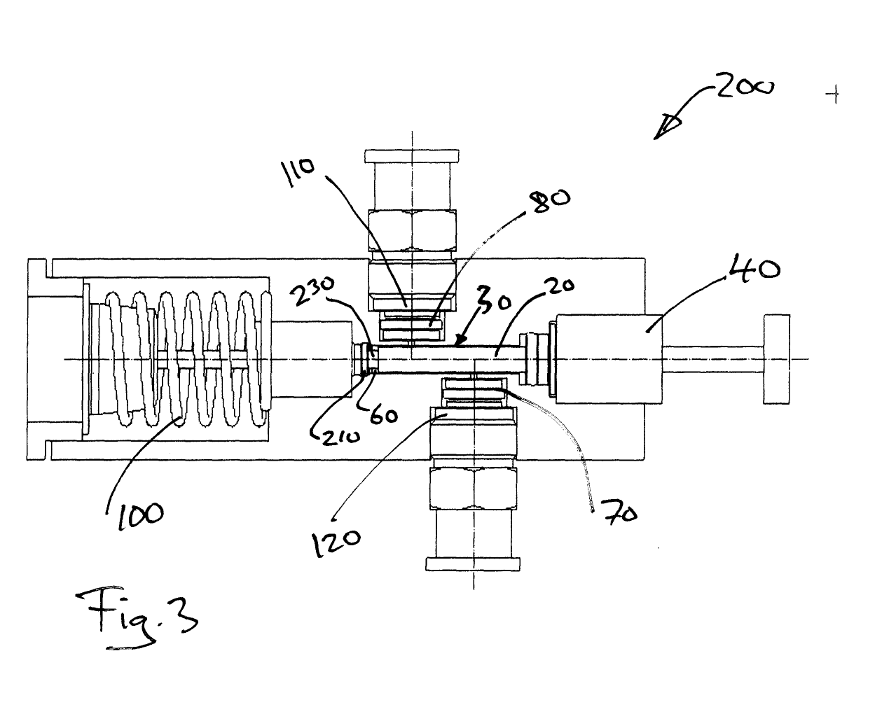

FIG. 3 shows another exemplarily embodiment of the pumping apparatus 200 in greater technical detail. The return mechanism 100 is embodied here by a spring.

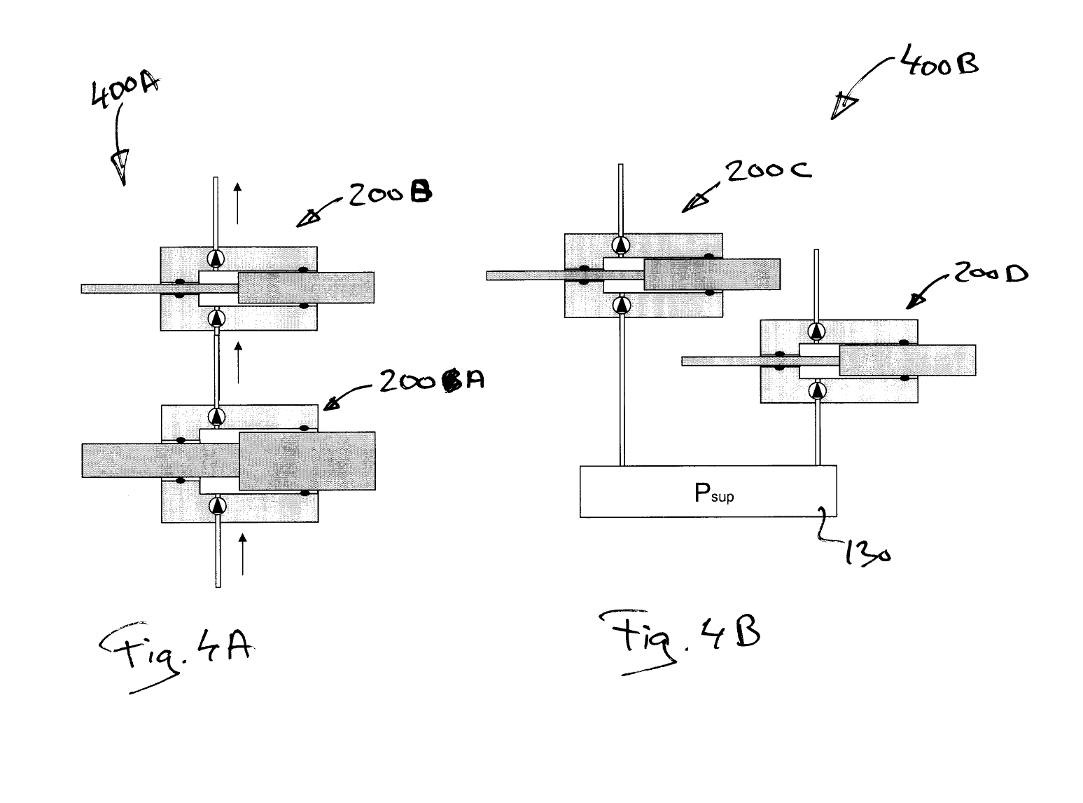

In the serial dual pump of FIG. 4a, a first pumping apparatus 200A is coupled at is input to a liquid supply (not shown), and its output is coupled to the input of a second pumping apparatus 200B. At least one and preferably both of the pumping apparatuses 200A and 200B are embodied in accordance with the aforementioned embodiments. In order to provide a continuous flow of liquid, the pump volume of the first pumping apparatus 200A might be embodied to be twice of the pump volume of the second pumping apparatus 200B, so that the first pumping apparatus 200A will supply a portion of its pump volume directly into the system and the remaining portion to supply the second pumping apparatus 200B, which will then supply the system during the intake phase of the first pumping apparatus 200A. The ratio of the pump volume of the first pumping apparatus 200A to the second pump operatives 200B is preferably 2:1, but any other meaningful ratio might be applied accordingly. Further details of the operation mode of such dual serial pump are disclosed in the aforementioned EP 309596 A1 and shall be incorporated herein by reference.

In the parallel dual pump of FIG. 4b, the inputs of a first pumping apparatus 210 and a second pumping apparatus 200D are coupled in parallel to the liquid supply 130, and the outputs of the two pumping apparatuses 200C and 200D are coupled in parallel to the system receiving the liquid at high pressure. The two pumping apparatuses 200C and 200D are operated usually with substantially 180 degree phase shift, so that only one pumping apparatus is supplying into the system while the other is intaking liquid from the supply 130. However, it is clear that also both pumping apparatuses 200C and 200D might be operated in parallel (i.e. concurrently), at least during certain transitional phases e.g. to provide a smooth(er) transition of the pumping cycles between the pumping apparatuses.

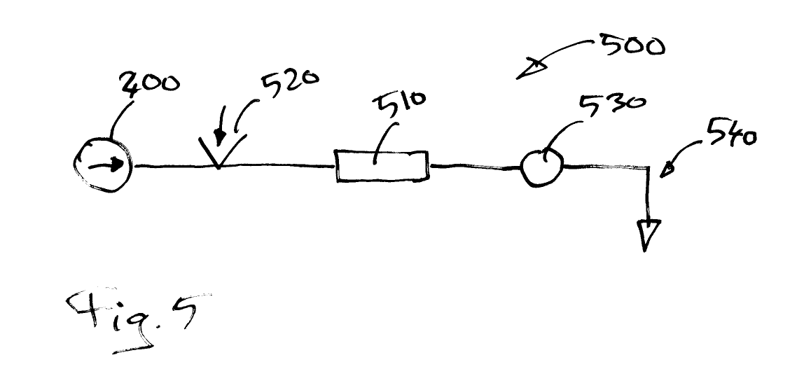

FIG. 5 shows a liquid separation system 500. A pump 400, which might be embodied as illustrated in FIG. 4a or 4b, drives a mobile phase through a separating device 510 comprising a stationary phase. A sampling unit 520 is provided between the pump 400 and the separating device 510 in order to introduce a sample fluid to the mobile phase. The stationary phase of the separating device 510 is adapted for separating compounds of the sample liquid. A detector 530 is provided for detecting separated compounds of the sample fluid. A fractionating unit 540 can be provided for outputting separated compounds of sample fluid.

Further details of such liquid separated system 500 are disclosed with respect to the Agilent 1200 Series Rapid Resolution LC system or the Agilent 1100 HPLC series, as both provided by the applicant Agilent Technologies, under www.agilent.com which shall be in cooperated herein by reference.

1. A pumping apparatus for delivering liquid at a high pressure at which compressibility of the liquid becomes noticeable, comprising
a piston adapted for reciprocation in opposing directions in a pump working chamber,
a drive coupled to the piston to apply a tension force onto the piston in order to move the piston into a drive direction, and
a return mechanism, coupled to the piston, being adapted for counteracting against the movement of the piston into the drive direction and to apply a tension force onto the piston in order to move the piston into a return direction opposite to the drive direction,
wherein the return mechanism is coupled to a side of the piston facing into pump working chamber.

2. The pumping apparatus of claim 1, comprising at least one of:
a return seal adapted for sealing the pump working chamber against a return mechanism counteracting against the movement of the piston;
a drive seal adapted for sealing the pump working chamber against the drive.

3. The pumping apparatus of claim 1, comprising at least one of:
a pump volume in the pump working chamber is increased when the piston is moved into the drive direction;
the pump volume in the pump working chamber is decreased when the piston is moved into the return direction;
a valve, coupled to the pump working chamber, to permit liquid flow only unidirectional;
an outlet coupled to the pump working chamber for outletting the liquid at the high pressure, wherein the outlet comprises an outlet valve adapted to permit liquid flow only unidirectional;
an inlet coupled to the pump working chamber for inletting the liquid at a pressure lower than the high pressure at the outlet, wherein the inlet comprises an inlet valve adapted to permit liquid flow only unidirectional;
the piston is at least partially coated with a diamond-like carbon coating adapted to provide a reduced abrasion of the piston.

4. The pumping apparatus of claim 1, wherein the drive comprises at least one of:
a spindle drive mechanism, a linear motor, a step motor;
a driving rod coupled to the piston.

5. The pumping apparatus of claim 1, wherein the return mechanism comprises at least one of:
a spring, a hydraulic cylinder, a drive mechanism, a deflection mechanism, a drive tension-coupled to the piston;
a return rod coupled to the piston.

6. A pump comprising
a first pumping apparatus of claim 1, and
a second pumping apparatus of claim 1,
wherein the first and the second pumping apparatus are coupled either
in a serial manner, with an outlet of the first pumping apparatus being coupled to an inlet of the second pumping apparatus, and an outlet of the second pumping apparatus providing an outlet of the pump, or
in a parallel manner, with an inlet of the first pumping apparatus being coupled to an inlet of the second pumping apparatus, and an outlet of the first pumping apparatus being coupled to an outlet of the second pumping apparatus, thus providing an outlet of the pump; and
a liquid outlet of the first pumping apparatus is phase shifted essentially 180 degrees, with respect to a liquid outlet of the second pumping apparatus.

7. A liquid separation system, comprising
a separating device comprising a stationary phase for separating compounds of a sample liquid in a mobile phase, and
a pump according to claim 6, adapted for driving a mobile phase through the separating device.

8. The separation system of claim 7, comprising at least one of:
a sampling unit adapted for introducing the sample fluid to the mobile phase,
a detector adapted for detecting separated compounds of the sample fluid,
a fractionating unit adapted for outputting separated compounds of the sample fluid.

9. A method of delivering a liquid at a high pressure at which compressibility of the liquid becomes noticeable, comprising
reciprocating a piston in opposing directions in a pump working chamber by applying a tension force onto the piston in order to move the piston into a drive direction, wherein a pump volume in the pump working chamber is increased when the piston is moved into the drive direction, and
counteracting against the movement of the piston into the drive direction by coupling to a side of the piston facing into pump working chamber, thus applying a tension force onto the piston in order to move the piston into a return direction opposite to the drive direction.

10. A software program or product, stored on a data carrier, for controlling the method of claim 9, when run on a data processing system.
